(19) United States
(12) Patent Application Publication
(10) Pub. No.: US 2013/0202961 A1
(43) Pub. Date: Aug. 8, 2013

(54) CATHODE UNIT FOR AN ALKALI METAL/SULFUR BATTERY

(71) Applicants: Markus Hagen, Kronau (DE); Holger Althues, Dresden (DE); Susanne Dörfler, Dresden (DE)

(72) Inventors: Markus Hagen, Kronau (DE); Holger Althues, Dresden (DE); Susanne Dörfler, Dresden (DE)

(73) Assignee: Fraunhofer-Gesellschaft Zur Forderung Der Angewandten Forschung E.V., Munchen (DE)

(21) Appl. No.: 13/806,800

(22) PCT Filed: Jul. 1, 2011
(86) PCT No.: PCT/EP2011/061134

§ 371 Date: Apr. 10, 2013

(30) Foreign Application Priority Data
Jul. 2, 2010 (DE) 10 2010 030 887.0

(51) Int. Cl. H01M 4/66; H01M 4/04

(52) U.S. Cl. CPC H01M 4/667; H01M 4/0404
USPC 429/211; 427/122

(57) ABSTRACT

The present invention relates to a cathode unit for an alkali metal-sulphur battery, comprising:
a cathode collector comprising a metal substrate,
carbon nanotubes which are fixed on the cathode collector and are in electrically conductive contact with the metal substrate,
an electrochemically active component which is present on the surface of the carbon nanotubes and is selected from sulphur or an alkali metal sulphide.

The present invention relates to a cathode unit for an alkali metal-sulphur battery and to a process for production thereof.

Lithium-sulphur batteries have theoretical capacities of 1672 mAh/g, which are more than five times as high as in the case of lithium ion batteries (150-280 mAh/g). In order to distinctly increase the energy density of batteries, it will be necessary in future to rely on alternative systems to lithium ion batteries, such as lithium-sulphur or sodium-sulphur.

Electrodes for batteries consist of electrochemically active and inactive material. The active material in the case of lithium ion batteries consists, for example, of LiCoO₂, LiMn₂O₄, LiNiO₂, S, graphite etc. The inactive material makes no contribution to the capacity of the electrode. The function thereof consists of the provision of adequate conductivity and the cohesion of the electrode. The passive material consists of conductive black and binder (e.g. PVdF, PVdF-co HFP, PTFE). In the case of sulphur cathodes, a porous carbon with high surface area is additionally present, and this takes up the sulphur.

In the conventional production of sulphur cathodes, the procedure is generally as follows. A porous carbon with high surface area is mixed with sulphur, ground and then heated. The sulphur-infiltrated carbon is then mixed with conductive black, a binder and a solvent. The paste thus produced is knife-coated onto a metallic collector. The solvent is vaporized and the paste is then compressed using a calender. Generally, a sulphur cathode consists of about 50% sulphur, 30% porous carbon and 10% each of binder and conductive black, and thus to an extent of approx. 50% by weight of electrochemically inactive material which makes no contribution to the capacity of the electrode.

It is an object of the present invention to provide a cathode unit for an alkali metal-sulphur battery with maximum capacity, and to provide a process for producing such a cathode, which can be performed in a very simple and efficient manner.

In a first aspect of the present invention, this object is achieved by the provision of a cathode unit for an alkali metal-sulphur battery, comprising:
a cathode collector comprising a metal substrate,
carbon nanotubes which are fixed on the cathode collector and are in electrically conductive contact with the metal substrate,
an electrochemically active component which is present on the surface of the carbon nanotubes and is selected from sulphur or an alkali metal sulphide.

In the context of the present invention, the term “cathode collector” is understood in its customary meaning familiar to those skilled in the art, and refers to the component of a battery which is in conductive contact with the electrochemically active material of the cathode and brings about the flow of current away from and to the active component of the electrode. A collector of an electrode is also referred to as a “current collector” (e.g. cathode current collector).

In the context of the present invention, the metallic substrate of the cathode collector may be manufactured from the metals typically used for this component.

The metallic substrate of the cathode collector preferably comprises one or more of the following metals or metal alloys: nickel, aluminium, iron, copper, molybdenum, gold, silver, or alloys thereof. In a preferred embodiment, nickel, aluminium or an alloy of these metals is used.

The cathode collector or the metallic substrate may, for example, take the form of a metal foil.

In the context of the present invention, it may be preferable for the metallic substrate to have an elevated specific surface area. The provision of an elevated metal surface area can be achieved by familiar measures, for example by an appropriate porosity or structuring (for example surface structuring, introduction of holes or orifices into the metal surface, etc.) of the metal substrate.

The metal substrate may, for example, comprise a porous metal, a metal structure provided with holes or orifices (preferably defined macroscopic holes or orifices) in the surface, a metal fabric, or a combination thereof.

In a preferred embodiment, the metallic substrate comprises a metal foam (e.g. nickel or aluminium metal foam), an expanded metal, a perforated metal or perforated sheet, a metal fabric, or else a combination of these metallic structures.

In the context of the present invention, the term “metal foam” is used in its customary definition familiar to those skilled in the art and relates to a porous foam composed of a metallic material.

In the context of the present invention, the term “expanded metal” is understood in its customary definition familiar to those skilled in the art and relates to a metallic material having orifices in the surface which arise from offset cuts without material loss with simultaneously expanding deformation.

The cathode collector may consist exclusively of the metallic substrate. In this case, the carbon nanotubes are fixed directly on the metallic substrate.

Alternatively, the cathode collector may additionally have further components.

In a specific embodiment, a substrate layer may be applied on the metallic substrate, the carbon nanotubes in turn being fixed on the former. If present, this layer should be configured such that electrically conductive contact between the carbon nanotubes and the metallic substrate of the cathode collector is ensured. In a preferred embodiment, this is achieved by virtue of the substrate layer having a very low thickness, the suitable thickness depending on the material of the substrate layer. Optionally, a conductive additive may also be added to the substrate layer.

As will be explained in more detail hereinafter, this substrate layer may be a catalyst layer. In a preferred embodiment, the catalyst layer comprises a cocatalyst layer on which at least one transition metal is present, for example in the form of a transition metal layer or in the form of transition metal particles. The cocatalyst layer may, for example, be an oxide layer, a nitride layer or oxynitride layer. Suitable materials for the cocatalyst layer may include aluminium oxide, silicon dioxide, magnesium oxide, titanium nitride or silicon nitride. Suitable transition metals may include Fe, Ni, Mo, Co, Cr, Mn or alloys thereof. As will be explained in more detail hereinafter, this catalyst layer, in a preferred production process for the inventive cathode unit, may catalyze the conversion of a carbonaceous precursor compound to the carbon nanotubes. The catalyst layer preferably has a thickness in the range from 5 nm to 100 nm, more preferably from 20 nm to 50 nm.

In a further preferred embodiment, the substrate layer is a polymer layer. This polymer layer fixes the carbon nanotubes on the cathode collector. In a preferred embodiment, the polymer layer comprises an adhesive. The polymer layer preferably has a thickness in the range from 0.01 μm to 30 μm, more preferably of 1 μm to 10 μm. Optionally, the electrically conductive contact between the carbon nanotubes fixed on the collector by the polymer layer and the metallic substrate of the collector can be improved by virtue of the polymer layer comprising electrically conductive additives.

Rather than a substrate layer, it is alternatively possible for particulate components to be present on the metallic substrate of the cathode collector. In a specific embodiment, these may be catalyst particles. As already mentioned above, the catalyst may catalyze the conversion of a carbonaceous precursor compound, for example ethene, to the carbon nanotubes. With regard to suitable transition metals, reference may be made to the above details.

The dimensions of the cathode collector can be varied within a wide range and also depend on the dimensions of the alkali metal-sulphur battery for which the cathode unit is intended.

In principle, the thickness of the cathode collector or of the metallic substrate can also be varied over a wide range. In the case of low thicknesses, it is possible to achieve flexible cathode collectors which enable a wound structure. Low thicknesses are also favourable with regard to a reduction in weight. A minimum thickness should be observed for reasons of sufficient mechanical stability, and of producibility and current conduction (minimum conductivity).

For example, the cathode collector or the metallic substrate may have a thickness in the range from 0.5 μm to 2 mm.

If the metallic substrate comprises a metallic foil or is in the form of a metallic foil, this foil should be very thin. The thickness of the foil is preferably in the range from 0.5 μm to 100 μm, more preferably from 10 μm to 50 μm, even more preferably from 12 μm to 30 μm.

In the case of the metallic substrates having porosity or a certain degree of structuring (for example metal foams, expanded metals etc.), the thickness selected may optionally be somewhat higher, for example up to 2 mm.

As explained above, the inventive cathode unit also comprises carbon nanotubes which are fixed on the cathode collector and are in electrically conductive contact with the metal substrate.

As already explained above, the electrically conductive contact between the metal substrate of the cathode collector and the carbon nanotubes can be ensured by virtue of the nanotubes being fixed directly on the metal substrate.

If a substrate layer, for example a catalyst layer or polymer layer, is present on the metal substrate and the nanotubes are not fixed directly on the metal substrate but on the substrate layer, this substrate layer is configured such that electrically conductive contact is also ensured between nanotubes and metal substrate. As explained above, this can be achieved, for example, by a very low thickness of this substrate layer.

In the context of the present invention, the expression “fixing of the carbon nanotubes on the cathode collector” is understood to mean that the interactions between the nanotubes and the surface of the cathode collector (i.e. either of the metallic substrate or of any substrate layer applied thereon) are sufficiently strong to fix the nanotubes permanently in a specific spatial orientation with respect to the collector surface.

In the context of the present invention, the term “carbon nanotubes” is understood in its customary definition familiar to those skilled in the art and relates to microscopically small tubular structures made of carbon, which can be understood as a rolled-up graphene layer (single-wall) or rolled-up graphene layers formed from a plurality of concentric tubes (multiwall).

The length of the carbon nanotubes may vary over a wide range. A suitable length in this context may, for example, be a range from 5 μm to 1000 μm.

The diameter of the nanotubes may, for example, be in the range of 0.1-100 nm, more preferably 1-50 nm, especially preferably 5-20 nm.

The carbon nanotubes are preferably present in an amount of 0.1 mg to 100 mg, more preferably of 0.5 mg to 20 mg, even more preferably of 1 mg to 10 mg, per cm² of cathode collector.

In a preferred embodiment, the carbon nanotubes are at least partly each anchored or fixed by one of the ends thereof in the surface of the cathode collector or metal substrate. Such fixing of the carbon nanotubes via one of the ends of each on the surface of the cathode collector or metal substrate can arise, for example, as an automatic consequence of the production process, for example a chemical gas phase deposition.

In a preferred embodiment, the longitudinal axes of the carbon nanotubes are aligned essentially at right angles to the surface of the cathode collector. The expression “essentially at right angles” also encompasses those carbon nanotubes whose longitudinal axis deviates by ±20° from a perfect perpendicular alignment. As will be explained in more detail hereinafter, this perpendicular alignment of the nanotubes relative to the collector surface may arise as an automatic consequence of a preferred production process if the growth of the nanotubes during the production process proceeds at right angles to the collector surface.

As explained above, the inventive cathode unit further comprises an electrochemically active component selected from sulphur or an alkali metal sulphide which is present on the surface of the carbon nanotubes.

In the context of the present invention, it is possible that the active component is present within the carbon nanotubes and/or on the outside thereof.

The sulphur as the electrochemically active component is preferably present in an amount of 0.5 mg to 10 mg per cm² of cathode collector.

If an alkali metal sulphide is used as the electrochemically active component, it is preferably lithium sulphide or sodium sulphide. In a preferred embodiment, it is Li₂S or Na₂S, but not a polysulphide.

The alkali metal sulphide as the electrochemically active component is preferably present in an amount of 0.5 mg to 10 mg/cm² of cathode collector.

In a further aspect of the present invention, an alkali metal-sulphur battery comprising the above-described cathode unit is provided.

This is preferably a lithium-sulphur battery or a sodium-sulphur battery.

The anode preferably comprises one or more of the following components: metallic lithium, metallic sodium, graphite, alloys of silicon or tin, composites, for example silicon with carbon, tin with carbon, hard carbons.

If the cathode unit comprises sulphur as the electrochemically active component, the anode in a preferred embodiment may comprise metallic lithium or metallic sodium.

If the cathode unit comprises an alkali metal sulphide, for example lithium or sodium sulphide, as the electrochemically active component, the anode in a preferred embodiment may comprise graphite, alloys of silicon or tin, composites, for example silicon with carbon, tin with carbon, hard carbons.

In a further aspect of the present invention, a process for producing the above-described cathode unit is provided, comprising the following process steps:
(i) providing a cathode collector comprising a metallic substrate,
(ii) fixing carbon nanotubes on the cathode collector such that electrically conductive contact is present between the carbon nanotubes and the metallic substrate,
(iii) applying an electrochemically active component to the surface of the carbon nanotubes, the electrochemically active component being selected from sulphur or an alkali metal sulphide.

With regard to the properties of the cathode collector and of the metallic substrate, reference may be made to the details already given above.

In a specific embodiment of the present invention, step (i) may also comprise the application of a substrate layer, for example of a catalyst layer or polymer layer, on the metal substrate of the cathode collector. Alternatively, rather than a catalyst layer, it is also possible to apply catalyst particles directly on the metallic substrate.

The substrate layer may be applied on the metallic substrate by commonly known deposition processes.

If a polymer layer is applied as the substrate layer, this is preferably an adhesive layer.

If the substrate layer is a catalyst layer comprising an inorganic cocatalyst layer, for example an oxide, nitride or oxynitride layer, this can be applied, for example, via a sol-gel process, a CVD process (i.e. chemical gas phase deposition) or a PVD process (physical gas phase deposition).

Sol-gel, CVD and PVD processes for coating of surfaces are known in principle to those skilled in the art.

In sol-gel processes, suitable precursor compounds (precursors), for example metal or semi-metal alkoxides, are generally converted by hydrolysis and subsequent thermal treatment (i.e. crosslinking of the hydrolyzed components) to corresponding oxide layers or nitride or oxynitride layers. Suitable precursors and suitable process conditions are known in principle to those skilled in the art.

For the application of an aluminium oxide layer on the metallic cathode collector, examples of suitable precursors include aluminium alkoxides such as aluminium isopropoxide or else mixed aluminium isopropoxide acetylacetonate complexes.

Suitable precursors for the application of an SiO₂ backing layer include, for example, silicon alkoxides such as silicon tetrasiloxane.

The precursor, or the already hydrolyzed conversion products thereof, can be applied by means of standard processes to the surface of the metallic substrate, for example by dip-coating, spin-coating, spray-coating, knife-coating, or printing processes. Subsequently, the hydrolysis of the precursor compound can optionally be continued and the oxide, nitride or oxynitride layer can be formed by appropriate thermal treatment. The catalytically active component, preferably one of the transition metals already mentioned above, can likewise be applied from the liquid phase, for example from solutions of organic metal salts. After application, these are preferably converted by thermal treatment to an oxide layer and later, preferably by means of reductive conditions (for example in a later CVD process for producing the carbon nanotubes on the cathode collector), to the catalytically active metal particles.

If a substrate layer is applied to the metallic substrate, the layer thickness thereof is preferably in the range from 5 nm to 100 nm, more preferably 20 nm to 50 nm. The process parameters with which the thickness of the layer deposited can be controlled are known in principle to those skilled in the art.

As mentioned above, in a further process step, (ii), carbon nanotubes are fixed on the cathode collector, such that there is electrically conductive contact between the carbon nanotubes and the metallic substrate.

In a preferred embodiment, the fixing of the carbon nanotubes is achieved by producing them on the surface of the cathode collector, for example by means of a chemical gas phase deposition process (CVD). The use of the surface of the cathode collector (i.e. either of the surface of the metallic substrate or the surface of the substrate layer, for example of the catalyst layer) as a reaction and deposition surface brings about firm fixing of the nanotubes on this collector surface.

Alternatively, it is also possible in the context of the present invention to produce the carbon nanotubes first on an external layer, i.e. one not present in the inventive cathode unit, for example on a layer which corresponds to the above-described catalyst layer, and then to transfer these nanotubes to a second layer (referred to hereinafter as transfer layer) and to fix them there. This transfer layer may be the substrate layer already applied to the metallic substrate (for example in the form of the polymer layer, preferably of the adhesive layer). Alternatively, the carbon nanotubes can first be transferred to the transfer layer and the transfer layer with the carbon nanotubes fixed thereon can subsequently be applied on the metallic substrate. An example of a suitable transfer layer is a polymer layer (for example an adhesive layer).

As already mentioned above, the carbon nanotubes, in a preferred embodiment, are produced directly on the surface of the cathode collector, preferably by means of a chemical gas phase deposition. The production of carbon nanotubes by means of a chemical gas phase deposition process is known in principle. In this process, there is catalytic decomposition of suitable carbonaceous precursor compounds. In the case of such a gas phase deposition process, it is preferable that, in step (i), the catalyst layer already described above is first applied on the metal substrate.

The chemical gas phase deposition preferably comprises the decomposition of a carbonaceous precursor compound in the presence of a catalyst.

The carbonaceous precursor compound is preferably selected from C₂₋₄-olefins, for example ethene, C₁₋₄-alkanes, for example methane or ethane, C₂₋₄-alkynes, for example acetylene, cycloalkanes, for example cyclohexane, aromatic hydrocarbons, for example xylene.

The catalyst preferably comprises one or more transition metals, for example Fe, Co, Mo, Ni, Cr, Mn, or an alloy of these transition metals.

The carbonaceous precursor compound is preferably contacted with the catalyst at a temperature in the range from 600° C. to 1000° C., more preferably of 725° C. to 750° C.

The carbonaceous precursor compound is preferably contacted with the catalyst at atmospheric pressure.

The carbon nanotubes grow in vertical alignment on the substrate within a particular catalyst layer thickness. The CVD process is preferably run at atmospheric pressure; it can thus be scaled up easily and be used for continuous coating of metal ribbons.

In the above-described preferred embodiment of direct production of the nanotubes on the surface of the cathode collector, carbon nanotubes whose longitudinal axes are aligned essentially at right angles to the surface of the cathode collector are obtained. The expression “essentially at right angles” also includes those carbon nanotubes whose longitudinal axis deviates by ±20° from a perfect perpendicular alignment.

The fixing of the carbon nanotubes on the cathode collector in step (ii) is followed, in step (iii), by the application of an electrochemically active component to the surface of the carbon nanotubes, the electrochemically active component comprising sulphur or an alkali metal sulphide such as lithium sulphide or sodium sulphide.

The electrochemically active component can be deposited on the surface of the carbon nanotubes by means of standard processes.

Sulphur can be applied to the carbon nanotubes using molten sulphur, sulphur sublimation, or sulphur dissolved in a solvent.

In a preferred embodiment, the sulphur is dissolved in a solvent and the solvent is contacted with the carbon nanotubes. Suitable solvents are nonpolar or only weakly polar substances, for example hexane, toluene, acetone, ammonia or carbon disulphide.

The use of a solvent offers the advantage that the electrochemically active component such as the sulphur can be applied in this way in a very fine, homogeneously distributed and controlled manner.

The selection of the temperature of the solvent can determine the amount of soluble sulphur. In general, the warmer the solvent, the more sulphur can be dissolved. The optimal amount of sulphur applied per unit area of the cathode collector depends on many factors (for example weight and height of the carbon nanotubes).

In a preferred embodiment, the amount of sulphur applied is 0.5 to 10.0 mg/cm² of cathode collector.

In a preferred embodiment, both the solvent comprising the sulphur and the metallic cathode collector are heated prior to and/or during the application of the sulphur in step (iii). Rapid or early crystallization of the sulphur on contacting of the solvent with the cathode collector and the carbon nanotubes is preferably prevented in this way. It is thus possible to achieve particularly homogeneous distribution of the sulphur, as described hereinafter using the example of toluene as the solvent.

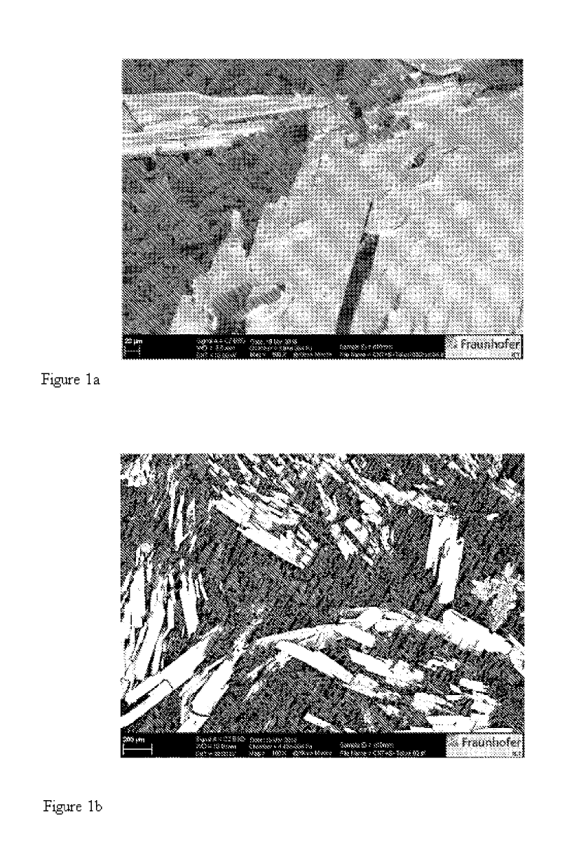

3.0 g of sulphur are dissolved in 40 ml of toluene at 80° C. 1.25 mg of sulphur can already be applied here theoretically with 17 μl. If the hot solvent is applied to a substrate at room temperature, elongated crystalline sulphur precipitates out immediately on the surface of the carbon nanotubes. As shown clearly in FIG. 1, the surface is not completely covered with sulphur.

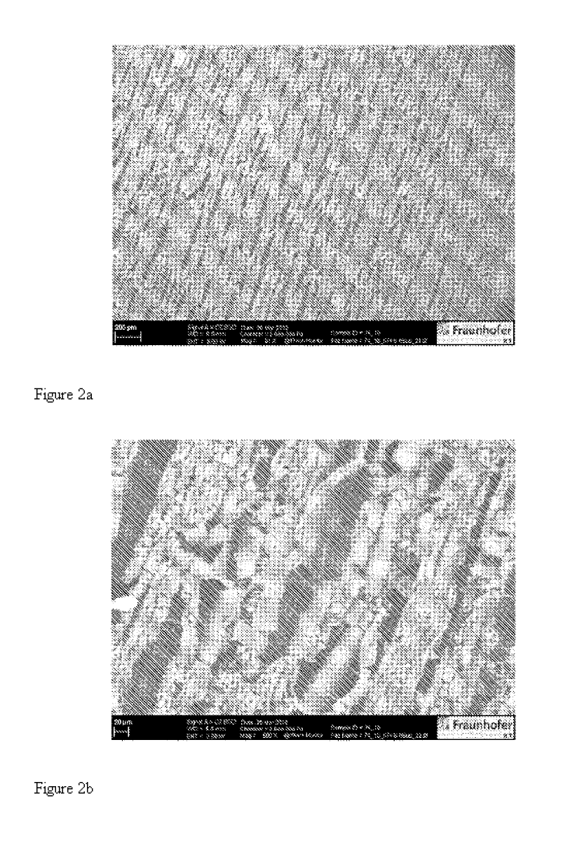

If, as wall as the solvent, the metallic cathode collector is also heated (hotplate >80° C.), crystallization of the sulphur as above can be prevented and a more homogeneous distribution can be achieved (cf. FIG. 2). If the cathode collector is heated for longer than 1 h, the sulphur diffuses deep into the carbon nanotubes.

If an alkali metal sulphide such as lithium or sodium sulphide is to be applied to the surface of the carbon nanotubes as the electrochemically active component, this can be accomplished in a preferred embodiment by first applying sulphur to the surface of the carbon nanotubes and then reacting it with a reactive alkali metal compound, preferably an organometallic alkali metal compound, for example n-butyl lithium or n-butyl sodium, to give an alkali metal sulphide. With regard to the application of the sulphur, reference may be made to the details above. The sulphur and the reactive alkali metal compound can be contacted by likewise supplying the reactive alkali metal compound via a solvent and bringing about the conversion to the alkali metal sulphide at elevated temperature.

In the context of the present invention, it is also possible to dissolve the alkali metal sulphide in a solvent (e.g. ethanol) and then to contact this solution with the surface of the carbon nanotubes, and it may be preferable for the metallic cathode collector to be heated before and/or during the application of the alkali metal sulphide solution.

The cathode unit obtainable by the process described above can be combined with a suitable anode in order thus to provide an alkali metal-sulphur battery. With regard to suitable anodes, reference may be made to the details given above.

The example which follows illustrates the present invention in detail.

### EXAMPLES

### Example 1

### Production of Carbon Nanotubes in Perpendicular Alignment on a Cathode Collector

For the wet-chemical deposition of the aluminium oxide layer, a mixed aluminium isopropoxide, acetylacetonate complex dissolved in isopropanol is used. The concentration is 60 g/l based on the hydrolyzed aluminium triisopropoxide starting material. The collector film to be coated (nickel) is immersed into the solution described, pulled out at 2.0 mm/s and then dried under air for 5 min. In the step which follows, a thermal treatment is effected under air at 300° C., likewise for 5 min. The catalyst layer which consists of a 2:3 ratio of iron:cobalt is likewise applied by means of dip-coating. For this purpose, a 0.22 M solution of Fe(2-ethylhexanoate)₃ and Co(2-ethylhexanoate)₂ in isopropanol is prepared. The Al₂O₃-coated collector foil is then immersed into the catalyst complex solution and pulled out at 3.0 mm/s. This is followed by drying at room temperature for 5 minutes and thermal treatment under air at 350° C. for 5 minutes. The twice-coated collector film is then placed into a quartz tube (diameter 40 mm) positioned in a tube oven with a hinged opening. In order to prevent reaction with atmospheric oxygen, the quartz tube is closed at both ends with KF flanges/gas distribution adapters and purged thoroughly with argon. The oven is then heated to 750° C. with a 3.0 slm Ar purge stream, with a prevailing temperature of 725 to 730° C. in the interior of the quartz tube at the substrate position. After the attainment of the temperature, 1.0 slm of argon, 0.67 slm of hydrogen, 0.17 slm of ethene and 85 ppm of water vapour flow simultaneously over the substrate. The water vapour is introduced with the aid of a stainless steel evaporator and argon as a carrier gas. After a growth time of 20 min, the oven is opened and cooled to approx. 200° C. under argon. Only then can the flange be opened and the coated substrate removed. With the specified growth time of 20 min, CNT layers of height up to 160 μm can be produced on nickel foil.

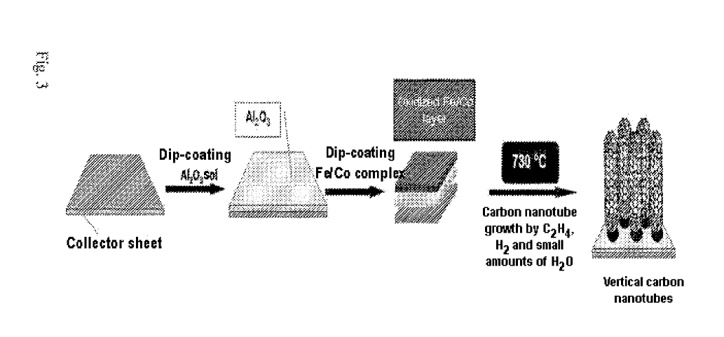

The process sequence is shown schematically in FIG. 3.

### Application of Sulphur Via a Solvent

3.0 g of sulphur were dissolved in 40 ml of toluene at 80° C. 1.25 mg of sulphur can already be applied here theoretically with 17 μl.

As well as the solvent, the metallic cathode collector is also heated (hotplate >80° C.), such that crystallization of the sulphur is prevented and a comparatively homogeneous distribution is achieved. The homogeneous distribution of the sulphur on the carbon nanotubes is shown in FIG. 2. If the collector is heated for longer than 1 h, the sulphur diffuses deep into the carbon nanotubes.

### Capacitive Measurements

Using a cathode which has been produced analogously to the example described above using solvent infiltration and with sulphur as the electrochemically active component, specific capacities were determined as a function of the number of cycles.

The comparative sample employed was a sulphur cathode obtainable by means of a conventional paste process as described in NATURE MATERIALS, Vol. 8, June 2009 (X. Ji et al.). In such a paste process, a porous carbon of high surface area is mixed with sulphur (mass ratio, for example, 3:7), ground and then heated to 155° C. At this temperature, sulphur is liquid, has the lowest viscosity and can thus flow efficiently into the pores of the carbon. The sulphur-infiltrated carbon is subsequently mixed with conductive black (e.g. super S carbon), a binder (e.g. PVdF) and a solvent (e.g. NMP, cyclopentanone etc.). The mass ratios are about 84% sulphur+carbon, 8% conductive black and 8% binder. The paste thus produced is knife-coated onto a collector sheet. The solvent is vaporized and the paste is then compacted by means of a calendar. Generally, such a sulphur cathode consists roughly of 50% sulphur, 30% porous carbon and 10% each of binder and conductive black.

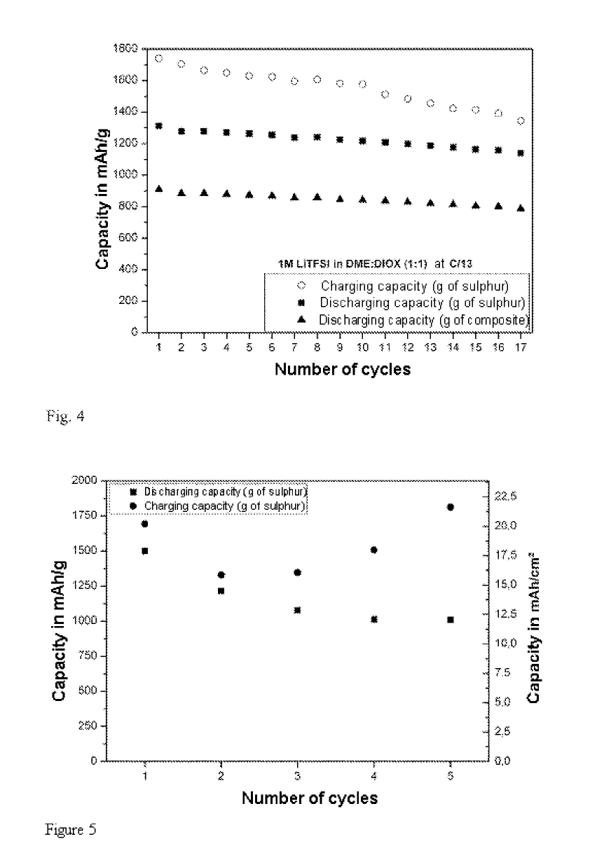

FIG. 4 shows the capacity values (based on the sulphur mass) as a function of the number of cycles of an inventive cathode unit with collector foil and vertically aligned carbon nanotubes applied thereon, compared to the sulphur cathode produced by the above-described paste process.

As can be inferred from FIG. 4, higher capacity values can be achieved with the inventive cathode unit.

### Example 2

Example 2 describes a sulphur electrode which has been produced with a cathode collector made from 110 ppi nickel foam.

Carbon nanotubes were applied to the collector by means of CVD with the aid of a catalyst substrate layer, and the electrode was then infiltrated with sulphur.

FIG. 5 shows the capacity of a nickel foam electrode with carbon nanotubes and sulphur over the first five cycles. 9.1 mg of sulphur were fused in over the collector of size 0.785 cm². The mass of the carbon nanotubes was 2.5 mg. The electrolyte used was 1M LiTFSI in DME:DIOX (2:1, v:v) with LiNO3 additive. The cell was cycled at a constant current of 0.5 mA against lithium metal between 1.0 and 3.0 V. The area capacities attained are between 12 and 15 mAh/cm². In comparison, lithium ion or lithium-sulphur cells produced conventionally by means of paste processes attain only 0.5-3.0 mAh/cm² at corresponding current densities.

### Example 3

Example 3 describes a sulphur electrode which has been produced with a cathode collector made from 110 ppi nickel foam.

Carbon nanotubes were applied to the collector by means of CVD with the aid of a catalyst substrate layer, and the electrode was then infiltrated with sulphur.

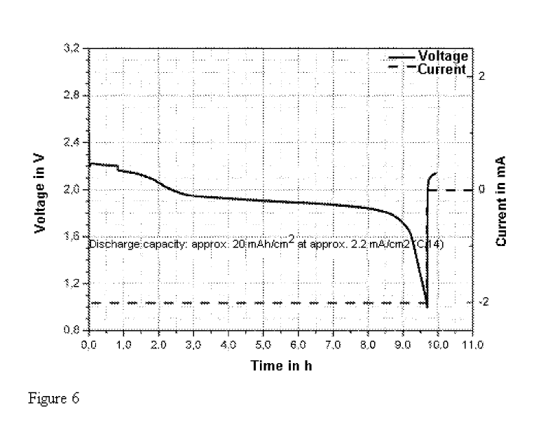

FIG. 6 shows the voltage and current plots for a nickel foam electrode with carbon nanotubes and sulphur in the first charging operation. 17.1 mg of sulphur were fused in over the collector of size 0.9 cm². The mass of the carbon nanotubes was 1.6 mg. The electrolyte used was 1M LiTFSI in DME:DIOX (2:1, v:v) with LiNO3 additive. The cell was cycled at a constant current of 2.2 mA/cm² of (C/14) electrode against lithium metal between 1.0 and 3.0 V. The area capacity attained in the first charging operation was approx. 20 mAh/cm². This corresponds to a capacity of approx. 1260 mAh/g of sulphur. In comparison, lithium ion or lithium-sulphur cells produced conventionally by means of paste processes attain only 0.5-3.0 mAh/cm² at corresponding current densities.

Examples 2 and 3 demonstrate that, for alkali metal-sulphur batteries, selection of collector structures with increased surface area and with subsequent carbon nanotubes coating allow a further improvement in the area capacities.

With regard to the advantages achievable by the present invention, the following can be stated:
It is possible to dispense with electrochemically inactive material (conductive black and binder). An average sulphur cathode consists of 50% sulphur (active material) and 50% inactive material (binder, conductive black, porous carbon with high surface area). The present invention can achieve sulphur cathodes with at least 70% active material and 30% inactive material. This leads to much higher capacities of the overall electrode!
Sulphur exploitation is very high (cf. FIG. 4) and is up to 85% and thus much higher than in the case of paste electrodes comprising binder and conductive black. Very high capacities are attained.
Sulphur infiltration by means of a solvent is very easy to control, inexpensive and effective. Processes via application of solid sulphur or sublimed sulphur are likewise possible.
The specific structure of the carbon nanotube electrodes achieves very low resistances. Since each carbon nanotube is fixed on the conductive substrate (i.e. metallic cathode collector), they are conductive pathways through the overall layer, without causing additional carbon/carbon contact resistances as present in conductive black-filled electrodes.
Continuous mass production is readily possible both on the part of the production of the carbon nanotubes and on the part of the application of the electrochemically active component.

1. Cathode unit for an alkali metal-sulphur battery, comprising:
a cathode collector comprising a metal substrate,
carbon nanotubes which are fixed on the cathode collector and are in electrically conductive contact with the metal substrate,
an electrochemically active component which is present on the surface of the carbon nanotubes and is selected from sulphur or an alkali metal sulphide.

2. Cathode unit according to claim 1, wherein the metal substrate comprises a porous metal, a metal structure provided with holes or orifices in the surface, a metal fabric, a metal foil, or a combination thereof.

3. Cathode unit according to claim 1, wherein the carbon nanotubes are fixed directly on the metal substrate.

4. Cathode unit according to claim 1, wherein a substrate layer is present on the metal substrate and the carbon nanotubes are fixed on the substrate layer.

5. Cathode unit according to claim 4, wherein the substrate layer is a catalyst layer or a polymer layer.

6. Cathode unit according to claim 1, wherein the cathode collector has a thickness in the range from 0.5 μm to 2 mm.

7. Cathode unit according to claim 1, wherein the carbon nanotubes are present in an amount of 0.1 mg to 100 mg/cm² of cathode collector; and/or the electrochemically active component is present in an amount of 0.5 mg to 10 mg/cm² of cathode collector.

8. Cathode unit according to claim 1, wherein the carbon nanotubes are each fixed by one of their ends on the surface of the cathode collector.

9. Cathode unit according to claim 1, wherein the longitudinal axes of the fixed carbon nanotubes are aligned essentially at right angles to the surface of the cathode collector.

10. Alkali metal-sulphur battery comprising the cathode unit according to claim 1.

11. Process for producing the cathode unit according to any of claim 1, comprising the following process steps:
(i) providing a cathode collector comprising a metallic substrate,
(ii) fixing carbon nanotubes on the cathode collector such that electrically conductive contact is present between the carbon nanotubes and the metallic substrate,
(iii) applying an electrochemically active component to the surface of the carbon nanotubes, the electrochemically active component being selected from sulphur or an alkali metal sulphide.

12. Process according to claim 11, wherein, in step (i), a substrate layer or a particulate component is applied to the metallic substrate.

13. Process according to claim 11, wherein, in step (ii), the carbon nanotubes are produced on the surface of the cathode collector, preferably by means of chemical gas phase deposition.

14. Process according to claim 11, wherein, in step (ii), the carbon nanotubes are produced on an external substrate and then transferred to a transfer layer.

15. Process according to claim 14, wherein the transfer layer is already present on the metallic substrate in the form of the substrate layer during the transfer of the carbon nanotubes, or alternatively the carbon nanotubes are first transferred to the transfer layer and the transfer layer with the carbon nanotubes fixed thereon is subsequently applied to the metallic substrate.

16. Process according to claim 11, wherein, in step (iii), the sulphur is dissolved in a solvent and the solvent is contacted with the carbon nanotubes; or the sulphur is first applied in powder form and is contacted with the carbon nanotubes by simultaneous or subsequent fusion.

17. Process according to claim 16, wherein both the solvent comprising the sulphur and the metallic cathode collector are heated prior to and/or during the application of the sulphur in step (iii).

18. Process according to claim 11, wherein sulphur is first applied to the surface of the carbon nanotubes and then reacted with a reactive alkali metal compound, preferably an organometallic alkali metal compound, to give an alkali metal sulphide.
